(19) United States
(12) Patent Application Publication
(10) Pub. No.: US 2013/0151979 A1
(43) Pub. Date: Jun. 13, 2013

(54) SYSTEM AND METHOD FOR ENTERPRISE UTILITY DATA AGGREGATION, MANAGEMENT, AND REPORTING

(71) Applicant: Energy Management Solutions, LLC d/b/a Entersp, New Albany, IN (US)

(72) Inventors: John Snider, Brownsburg, IN (US); Hershel (Ed) Fancher, Georgetown, IN (US); Michael Van Vertloo, Indianapolis, IN (US); Robert Zigon, Carmel, IN (US); Chris Frolik, Carmel, IN (US); Peter Nei, Indianapolis, IN (US)

(21) Appl. No.: 13/708,034

(22) Filed: Dec. 7, 2012

Related U.S. Application Data
(60) Provisional application No. 61/568,307, filed on Dec. 8, 2011.

(51) Int. Cl. G06F 3/0484

(52) U.S. Cl. CPC G06F 3/0484
USPC 715/738

(57) ABSTRACT

Disclosed is an automated utility data aggregation, warehousing, management, and reporting platform. Also disclosed is a universal multi-location utility monitoring service suitable for collecting granular data from any utility meter (e.g. energy, water, or gas meters) or the like and evaluating the efficiency of various aspects of the system based upon the data collected, its user specified definition, and up to date information acquired from various external sources. The service operates at a central server which collects information from a number of potentially diverse sources for inclusion in a database. In one form, the central server collects static data—such as initial setup and factual information with respect to an entity, dynamic data—such as utility data, and acquired data—such as current weather and publicly available utility costs.

### CROSS-REFERENCE TO RELATED APPLICATIONS

This application claims the benefit of U.S. Provisional Application Ser. No. 61/568,307, filed Dec. 8, 2011 which is hereby incorporated by reference in its entirety.

### BACKGROUND

As commodity prices increase, efforts to improve efficiency are quickly becoming the best avenue for businesses looking to lower the costs of their operations. Utilities, including electricity, natural gas, and water, present ample opportunities for cost savings through improvements in their utilization. Reduction of consumption, timing of use, and manner of deployment can all result in significant cost savings. For instance, peak electric use charges can be a substantial portion of an industrial customer's electrical utility bill. Simply redistributing the times when power-intensive equipment is used can result in significant savings. As another example, recycling the heat from used hot water flowing down a drain can reduce the cost of heating the incoming source water.

Massive utility savings are out there and their associated cost reductions can be had by simply recognizing cost saving opportunities and implementing a strategic plan for the corresponding utility use.

In the real world, identifying and evaluating potential utility cost saving opportunities is difficult and extremely complex. Implementation of utility cost saving measures can also be a challenge, and may take considerable investments in time and money to realize. As a result, absent concrete evidence of where savings will be obtained and the magnitude of those savings, businesses are reluctant to invest the up-front capital required to make the changes. Therefore, a solution is needed whereby granular utility data may be easily gathered, managed, and analyzed to help identify these opportunities and subsequently to confirm the energy savings of projects undertaken.

Furthermore, a solution is needed whereby granular utility data is analyzed to identify equipment or machinery which is operating out of its normal range, or out of its normal range under the current circumstances, in order to conserve energy or reduce maintenance costs. Equipment of machinery that is using more of a resource (air, water, electricity, etc.) may be doing so because of improper or inadequate maintenance or because of wear or other damage.

The same types of granular utility data can serve cost savings needs in many ways. However, this can only be accomplished if the data are properly collected, stored, analyzed, and distributed. The present invention solves the problem of collecting, storing, analyzing, and distributing necessary information for deducing and ultimately improving overall utility costs as it pertains to any of a number of selected and/or identified areas within an entity, such as an organization, corporation, campus, municipality, or a portion thereof. In doing so, the present invention bring a level of flexibility which allows for just about any type of sensor to be utilized with the system absent the need for pre-programming or dedicated drivers.

### SUMMARY

A system for receiving utility data from a plurality of devices is disclosed. In one embodiment, the data received is segregated into defined channels with each channel having a user-specified unit type. Furthermore, several calculated channels are created from those channels based upon mathematical formulas.

In a further embodiment, dynamic reports and dashboard views are created based upon the calculated channels. Those dynamic reports and dashboard views are hosted at static unique web addresses to facilitate their subsequent distribution and display.

Further objects, features and advantages of the present invention shall become apparent from the detailed drawings and descriptions provided herein. Each embodiment described herein is not intended to address every object described herein, and each embodiment does not include each feature described. Some or all of these features may be present in the corresponding independent or dependent claims, but should not be construed to be a limitation unless expressly recited in a particular claim.

### BRIEF DESCRIPTION OF THE DRAWINGS

FIG. 1 is a plan view of a utility data monitoring system according to one form of the present invention.

FIG. 2 is a representative screen shot illustrating one facility setup screen displayed by the web-based application hosted by the servers of the system of FIG. 1.

FIG. 3 is a representative screen shot illustrating one channel setup screen displayed by the web-based application hosted by the servers of the system of FIG. 1.

FIG. 4 is a representative screen shot illustrating one calculated channel setup screen displayed by the web-based application hosted by the servers of the system of FIG. 1.

FIG. 5A is a representative screen shot illustrating one report setup screen displayed by the web-based application hosted by the servers of the system of FIG. 1.

FIG. 5B is a representative screen shot illustrating another report setup screen displayed by the web-based application for continuously updating dashboard setup hosted by the servers of the system of FIG. 1.

FIG. 6 is a representative screen shot illustrating one dashboard view screen displayed by the web-based application hosted by the servers of the system of FIG. 1.

FIG. 7 is a representative screen shot illustrating one alert setup screen displayed by the web-based application hosted by the servers of the system of FIG. 1.

FIG. 8 is a representative screen shot illustrating one sensor layout screen displayed by the web-based application hosted by the servers of the system of FIG. 1.

### DESCRIPTION OF THE SPECIFIC EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

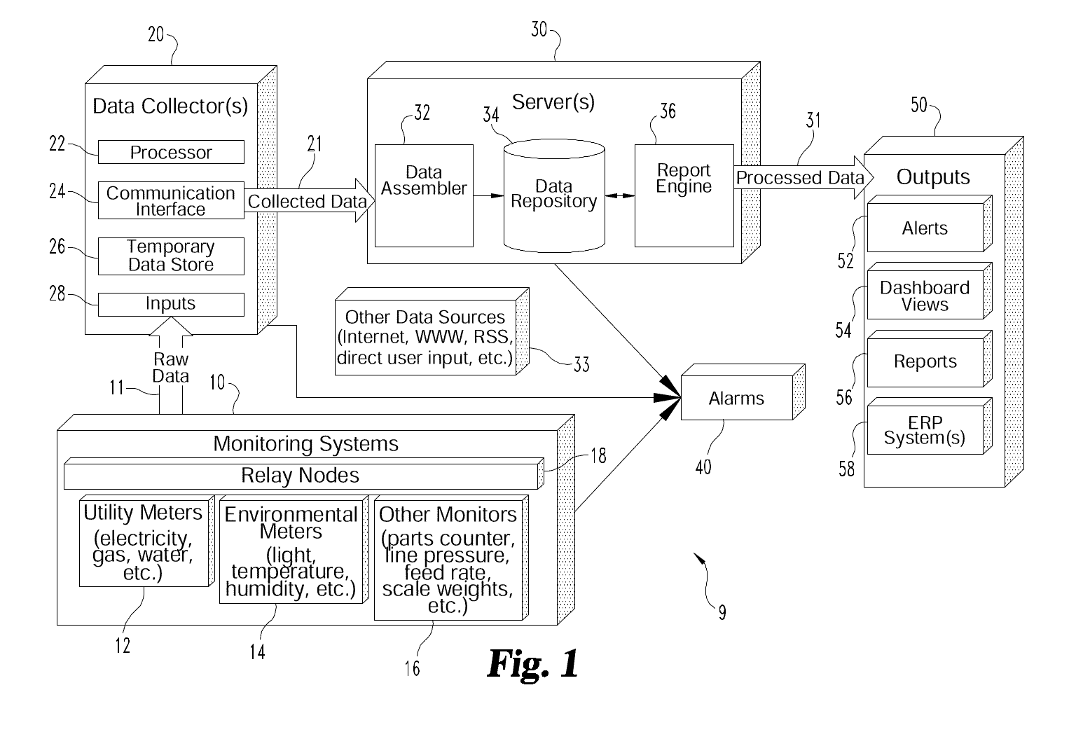

Disclosed is an automated utility data aggregation, warehousing, management, and reporting platform. Also disclosed is a universal multi-location utility monitoring service suitable for collecting granular data from any utility meter (e.g. energy, water, or gas meters) or the like and evaluating the efficiency of various aspects of the system based upon the data collected, its user specified definition, and up to date information acquired from various external sources. The service operates at a central server which collects information from a number of potentially diverse sources for inclusion in a database. In one form, the central server collects static data—such as initial setup and factual information with respect to an entity, dynamic data—such as utility data, and acquired data—such as current weather and publicly available utility costs. Turning to FIG. 1, a plan view of a utility data monitoring system 9 according to one embodiment of the present invention is shown. The system 9 includes a network of devices, such as those within monitoring systems 10, for collecting and transmitting dynamic data 11 to one or more data collectors 20, which then transmit the collected data 21 to one or more central servers 30 on a periodic basis. Once the dynamic data 11 is transmitted to the central servers 30 it may be defined by the user for subsequent use. Once the dynamic data 11 has meaning, may be processed, stored, and subsequently transmitted as processed data 31 for various types of output 50. Alternatively or additionally, alarms 40 may be triggered by any subcomponent of the system 9 when errors or unusual data are encountered.

It shall be appreciated that only one example monitoring system 10, only one data collector 20, and only one server 30 are shown to preserve clarity, but that any number of each may be included and/or interconnected to provide the desired functionality for one or more entities. For example, one or more utility meters 12 may be used with a relay node 18 in order to gather and transmit utility data to a data collector 20. The use of relay nodes 18 depends on several factors such as wireless transmission ranges, utility locations, and sub-metering desires. Environmental meters 14 and other monitors 16 may utilize the same relay node, different relay nodes, or no relay nodes to accomplish their data transmission to the data collector 20. Additionally, an organization may include one or more data collectors 20 at each facility being monitored, with each data collector 20 servicing one or more monitoring systems 10, depending on the size and scope of the monitoring being performed. For example, a data collector 20 and corresponding monitoring system(s) 10 may be included within each building located on a monitored site. Accordingly, servers 30 will be located at a distinct geographic location from monitoring systems 10 and data collectors 20, such as greater than 1 mile, 5 miles, or 20 miles. Furthermore, servers 30 may communicate with multiple combinations of monitoring systems 10 and data collectors 20, including where those combinations themselves are located are different geographic locations, such as those which are greater than 1 mile, 5 miles, or 20 miles apart.

It shall also be appreciated that only a few types of conceivable outputs 50 are shown, but that any number of outputs, including those of various types known to those of skill in the art, are contemplated. Likewise, the processed data 31 is not the only avenue of generating outputs, but is the primary one envisioned for the current embodiment of the system. Outputs 50 could also be generated from the data assembler 32 or the data repository 34 by various means. Indeed, working examples of dashboard views 54 generated by querying the data repository 34 have been demonstrated in practice. The four primary types of outputs 50 currently envisioned are alerts 52, dashboard views 54, reports 56, and ERP system inputs 58. Example illustrations of these output types are provided herein.

Turning to the specifics of the system in FIG. 1, a monitoring system 10 consists of zero or more utility meters 12, zero or more environmental meters 14, and zero or more other monitors 16, with zero or more relay nodes 18 used as needed. These components may be utilized in any combination, so long as their total is at least one, as needed for any specific monitoring situation. Monitoring systems 10 make granular measurements of various entities, such as energy consumption in total kilowatt hours, relative humidity as a percentage, or production rate in parts per hour. These measurements are derived from the data provided via connection to third-party utility meters 12, environmental meters 14, and other monitors 16, and are made on a periodic basis, such as every 60 seconds, every 15 minutes, every hour, or every part passing a sensor on a conveyor. In one form, a monitoring system 10 may be a wired, Modbus-enabled electrical meter, such as the PowerScout Networked Power Meters, offered by DENT Instruments located at 925 SW Emkay Drive, Bend, Oreg. 97702. It may be necessary in some circumstances to include one or more relay nodes 18 to enable raw data transmission 11 to data collectors 20. In one form, the data received by relay node 18 is transmitted via wireless radio signals. In a further form, relay node 18 may compress, queue, or encrypt the data prior to transmission for efficiency or to address wireless network downtime, security, or airtime/bandwidth cost concerns. In one form, the relay node 18 may be a wireless transceiver, such as the ModHopper, offered by Obvius located at 3300 NW 211th Terrace, Hillsboro, Oreg. 97124. Regardless of their implementation, monitoring systems get raw data 11 to data collectors 20, which are then responsible for handling the collected data 21 and passing it along to servers 30.

A data collector 20 includes a processor 22, a communication interface 24 configured to communicate, either through a wired or wireless connection, with one or more servers 30, temporary data store 26, and one or more input ports 28 for connection to monitoring systems 10. Processor 22 of data collector 20 is programmed to handle the incoming stream of input data 11 connected to the inputs 28, storing the raw data in a temporary data store 26, and periodically communicating the collected data 21 via a communication interface 24. The granular raw data 11 is stored within temporary data store 26, which may be any form of electronic storage, such as one or more types of solid-state electronic memory, magnetic memory, or optical memory, just to name a few. In another form, the data collector 20 may be configured to connect to a file transfer protocol (FTP) site on servers 30, such as with respect to data repository 34. Each data collector 20 may be provided with a specific location, folder of the like where it is to store the collected data 21. In a further form, there may be separate folders for each monitoring system 10, each data collector 20, each facility, each entity, or the like. Preferably, the FTP site is secured, such a by access credentials, which may be provided to the monitoring user or stored within data collector 20 during configuration.

In one form, the data collector 20 may be a Modbus-enabled device capable of wired and wireless communication, such as the AcquiSuite, offered by Obvius located at 3300 NW 211th Terrace, Hillsboro, Oreg. 97124. It should be noted that in some forms, relay nodes 18 are not required and even the monitoring system 10 and data collector 20 may be combined into a single device, in which case raw data 11 is handled internally to the device; in fact, the AcquiSuite is capable of operating in this configuration. Data collectors 20 transmit the collected data 21 to one or more servers 30 for storage, processing, and reporting.

Servers 30 operate via the combination of a data assembler 32, a data repository 34, and a report engine 36. It shall be appreciated that these components may be comprised of software modules and/or business logic which is resident on servers 30. One or more of the servers which make up servers 30 is operatively connected to a communications media (e.g., the Internet, local area network, wide area network, or digital network) so as to receive the collected data 21 from one or more data collectors 20. Once received, the collected data 21 is processed by the data assembler 32 and stored within a data repository 34 in a format designed to facilitate later reporting. For example, formatted utility data is associated with an entity, such as the operator of the location at which the data was collected. The formatted data may also be further associated with a specific division, location, branch, or the like of an organization, depending upon where it is received from. For example, the files may be provided with an indication of the associations or those associations may be determined from the device the files are received from or which folder the files were uploaded to. Beyond this simple type of association, more complex types of associations are made, such as correlating data by time stamp, internet protocol addresses, hardware IDs, or serial numbers across monitoring systems 10 at different locations. Additionally, the data repository 34 is operationally connected to a report engine 36 which is operable to present data analysis and reporting applications to a set of subscribing remote users. In one form, the remote users are the set of authorized users designated by each entity whose facilities include one or more monitoring systems 10 and data collectors 20, and which are currently subscribed to the service. Furthermore, the data analysis and reporting application presented to each remote user is operable only upon the portion of the data maintained within the data repository 34 which is attributed to their associated entity.

In addition to receiving and processing the collected data 21, servers 30 are capable of collecting and correlating other types of pertinent data from other data sources 33 for inclusion in their respective data repositories 34 via data assemblers 32. These additional types of data may include data such as weather information, minute-by-minute temperature, wind speed, relative humidity, cloudiness, and precipitation readings received via an RSS feed from a national or local weather station for a specific location. In one form, the weather station may be operated by the National Weather Service. Additionally, current energy rates may be collected from a number of applicable energy providers, such as by screen scraping of energy provider web pages or other data acquisition methods. In addition, data may be input directly by users to accommodate data not readily available by other means.

The servers 30, in conjunction with the various other components of the system, provide one or more user interfaces, which allow a user to log in from a remote location and monitor the current status of various monitored systems 10. For example, total energy consumption or the energy consumption of a particular sub-system or component according to the data received from its collective/associated utility meters 12. Additionally, historical data, such as the past 24 hours, past week, current month, current year, or some other specified period of energy usage statistics may be provided. The user interface may take various forms, from an installed application on a computer, to a web site, to a mobile device application. The user interface aspect of the system is not shown in FIG. 1, as it may encompass interfacing with any or all components of the entire system. In one form, it may not even be interactive, such as a dashboard view 54 that simply displays processed data 31 in a particular manner. In another form, it may be an interactive application capable of system configuration, monitoring, reporting, and data export.

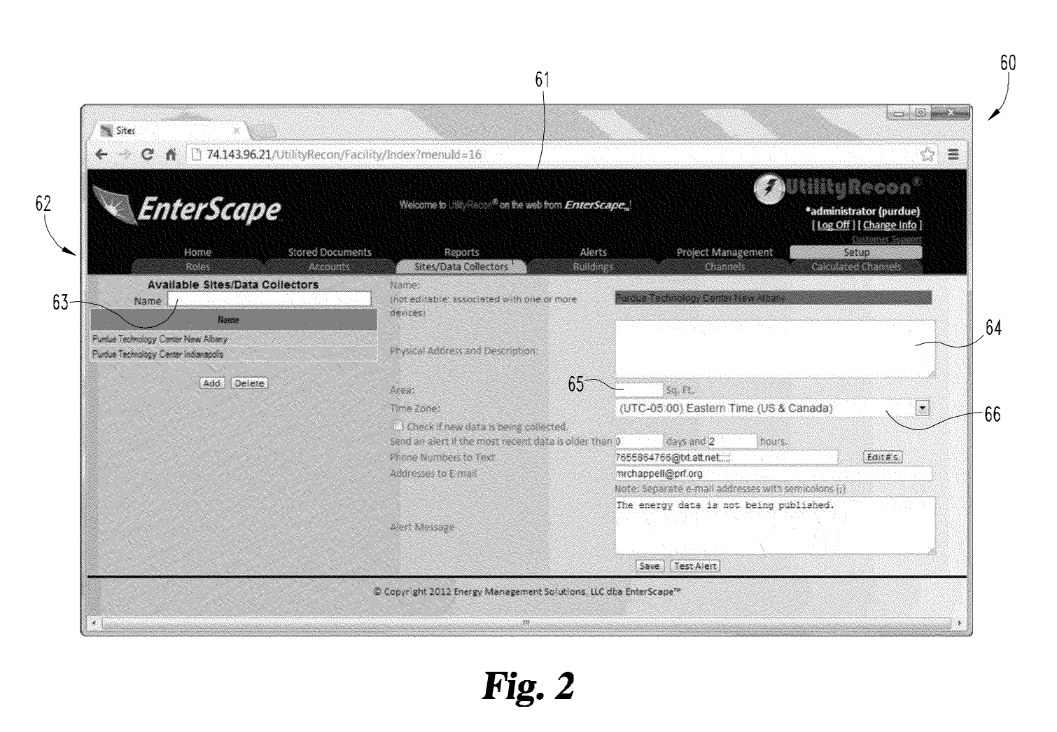

In the illustrated embodiment represented in FIG. 1, the system provides a user interface in the form of a web-based application. The application consists of a series of pages, such as pages 60, 70, and 80 shown in FIGS. 2-4 respectively, in order to collect a variety of initial configuration information, such as information defining an entity, the type of the system, the normal operating specifications, the system's location, the number of sub-parts (tenants) defined within the system and their corresponding monitoring systems 10 and data collectors 20, their associated energy supplier, etc. (the static data). Additionally, account information for a set of authorized users who are permitted to access the entity's information at one of a number of defined levels of access may be specified at this point.

Turning to FIGS. 2-4, with continued reference to FIG. 1, the process for configuring a new facility for monitoring using system 9 will be described. The following description will assume that monitoring system(s) 10 and data collector(s) 20 have already been installed, but it shall be appreciated that the configuration steps may occur in opposite order if desired.

FIG. 2 is a representative screen shot illustrating one screen 60 displayed by the web-based application hosted by servers 30. Screen shot 60 illustrates the screen displayed upon the user's selection of the “Sites/Data Collectors” tab 61 on the navigation bar 62 located at the top portion of screen 60, which may be displayed on other screens, including the home screen of the web-based application. The home screen is preferably accessed after a user logs into the web-based application, such as by entering an authorized username/password combination or the like. Screen 60 enables a user to enter static data which defines one or more facilities to be monitored in association by the system of FIG. 1. For example, the system may monitor a single facility or it may monitor multiple facilities associated with the user. A facility is defined by a name, description, area, and time zone, which are entered into field 63, 64, 65, and 66 respectively. The name of the facility will be user subsequently to identify the facility when associating data, monitoring systems, and running reports. Furthermore, a time zone is provided as, in one form, the data is received using a universal time which must then be offset to adjust for the location of the associated facility. Upon saving the new facility, it will appear in the list of facilities 75, which also enables a user to search for and delete existing facilities.

When a new facility is established, according to one for of the present invention, a data folder is established within data repository 34 of FIG. 1. Accordingly, any monitoring station(s) 10 and/or data collector(s) 20 which are operated at the new facility may be configured so as to provide their collected data 21 into the appropriate folder. In the case where data repository 34 includes an FTP server, monitoring station(s) 10 and/or data collector(s) 20 may be provided with access credentials or other information to enable them to upload their collected data 21 to the appropriate location or folder. It shall be appreciated that this information may be manually provided to the various devices during configuration and/or installation.

Once a facility is established, the system 9 may begin to receive data from the devices of monitoring system(s) 10. However, at this point, the data received by system 9 may not have any particular meaning. For example, the data may be in tabular form without any specific meaning assigned to each column, row, or the like. Furthermore, the data may be received in one of many forms, including a comma separate value format.

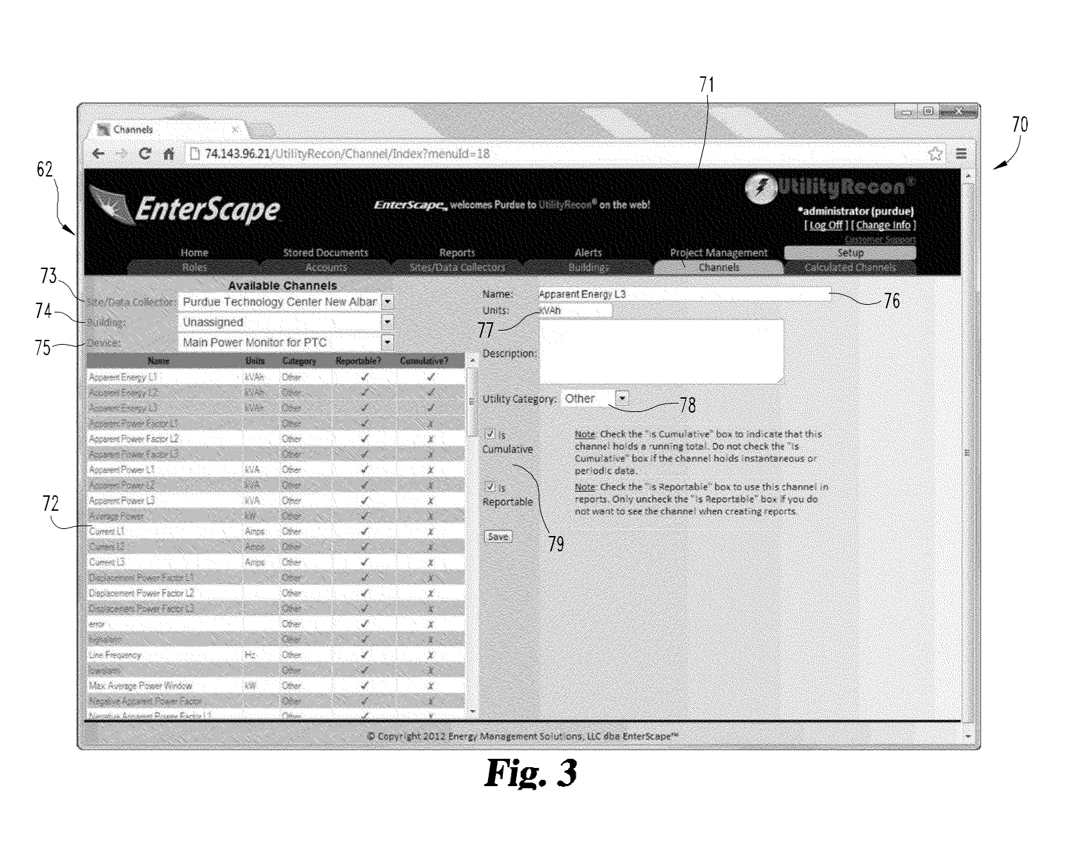

Turning to FIG. 3, a representative screen shot illustrating another screen 70 displayed by the web-based application hosted by servers is shown. Screen shot 70 illustrates the screen displayed upon the user's selection of the “Channels” tab 71 on the navigation bar 62 located at the top portion of screen 70 (or on another screen). Screen 70 enables a user to define one or more “channels” within the collected data 21. For example, one data channel may be the actual temperature taken at a certain point, while another data channel may be the current load on a selected power meter. Furthermore, it shall be appreciated that one or more channels may be provided by the same device, such as a utility meter 12.

List box 72 shows a listing of all of the current channels which are defined and accessible to the current user. Furthermore, should the user choose, the channels included within list box 72 may be pared down by selecting a particular facility, building or device within drop down boxes 73, 74 and/or 75. Additionally, the screen 70, in a further form, may provide a search box to enable a user to further or more quickly pare down the resulting channels displayed.

Focusing on the right hand portion of screen 70, the creating of a new channel will now be described. Initially, a new channel is provided with a name which is entered into name field 76. Additionally, the units associated with the new channel are entered into field 77. In another form, the units may selected from a pre-defined list via a drop down box, which preferably includes a wide variety of common units, such as degrees, kilowatts, kilowatts/hour, % humidity, gallons, gallons per minute, just to name a few representative examples. It shall be appreciated that a pre-defined list may be supplemented by the user if desired to include any unit label desired. In addition to a unit type, each channel may also be identified with a particular utility category by a category drop down box 78. Exemplary categories for use include electric, water, gas, environment, etc. These categories may be used to quickly add large numbers of channels to reports based upon their type. Also required for each channel is an indication of whether the channel is cumulative, meaning that each data point received is in addition to those previously received. This indication is made by selecting or not leaving empty check box 79. One example of a cumulative channel would be one which is received from a flow meter which merely pulses upon the occurrence of an event, such as the flow of a specified volume of liquid or the like.

System 9 also provides for the creating of “calculated channels” which are similar to channels except that they may be a combination of one or more channels. Furthermore, each calculated channel is defined by a mathematical equation having at least one mathematical operator, such as “+”, “−”, “*” or “/”. This enables a user to arrive at a calculated channel for subsequent use in reporting, monitoring, or alarm generation without requiring a specific monitoring device or device driver. For example, in the event of a pulse-based flow meter, a calculated channel may be created where the definition is “30*# of pulses” (in gallons). Furthermore, in the case facility with six air conditions, their load may be calculated by monitoring the load on the pane they are connected to as well as monitoring the devices connected to that panel which aren't air conditioners, and creating a calculated channel which subtracts the other devices from the load detected at the panel. This may result in efficiencies, such as a reduction in the number of utility meters or the like required to achieve the desired monitoring.

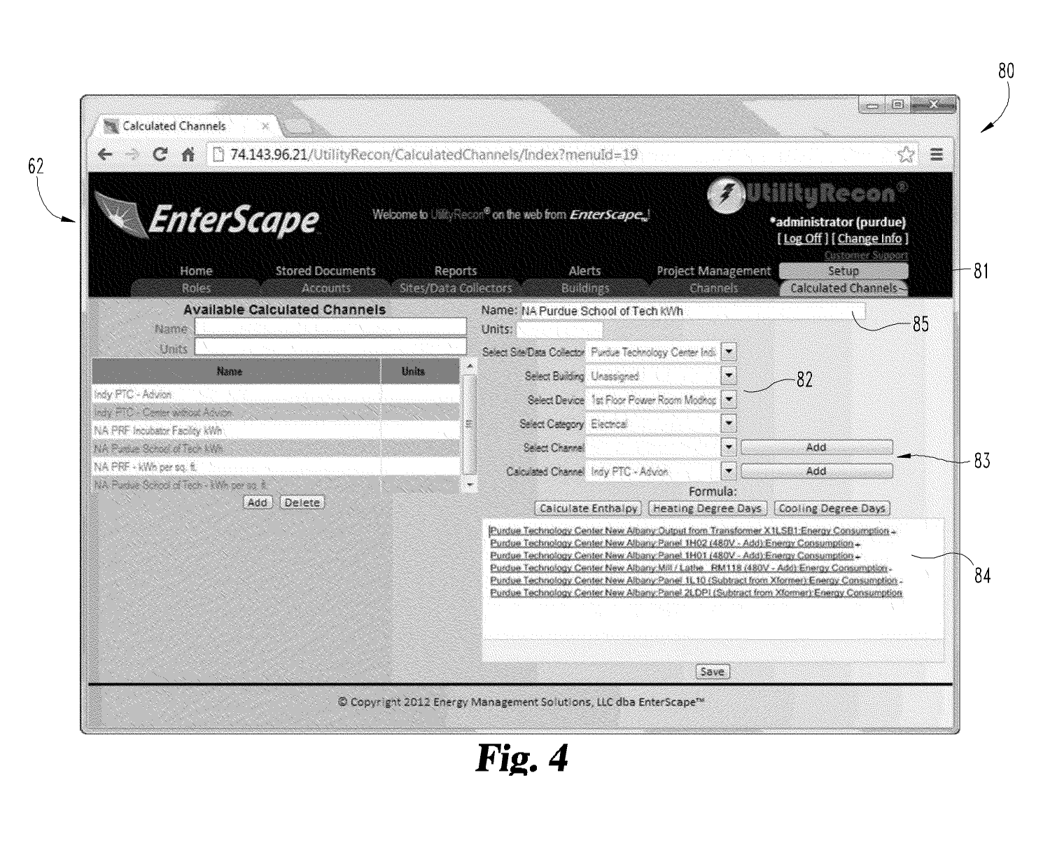

As shown in FIG. 4, the user interface may provide a page, such as the illustrative page shown by screen shot 80, which allows a user to specify “channels” (which are individual data sources/types) for use in generating a “calculated channel” for use. Screen shot 80 illustrates the screen displayed upon the user's selection of the “Calculated Channels” tab 81 on the navigation bar 62 located at the top portion of screen 80 (or on another screen). These channels are selected by selecting their appropriate identifying information using drop down boxes 82 and subsequently added to calculated channel equation field 84 by selecting the appropriate “Add” button 83. This enables a user to define a new data type based upon a specified relationship of the various other known channels. For example, one calculated channel may be the average of one channel multiplied by the value of another channel. Once created and given a name within name field 85, these calculated channels may be used in reports, and subsequently are implemented in separate columns of the resulting reports, which in this form, are Microsoft Excel Spreadsheets. Since the text typed into the calculated channel control is maintained verbatim in the report, the user has the ability to continue to make complex calculations with ease.

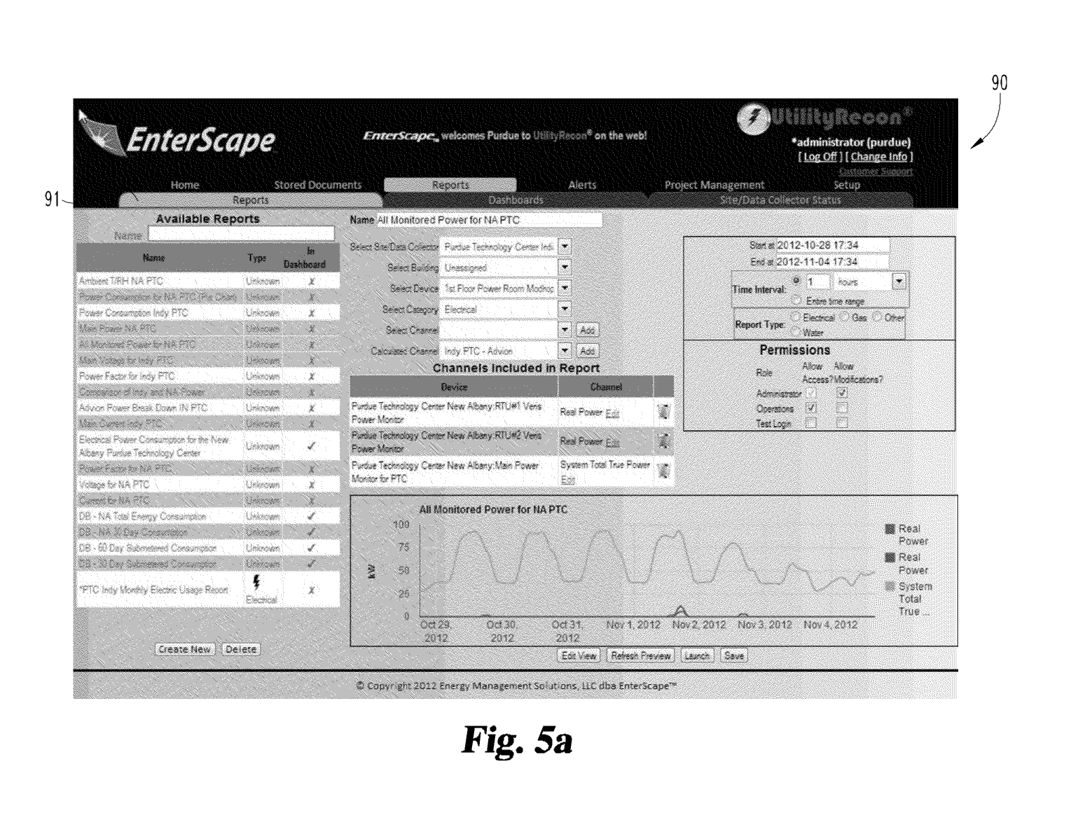

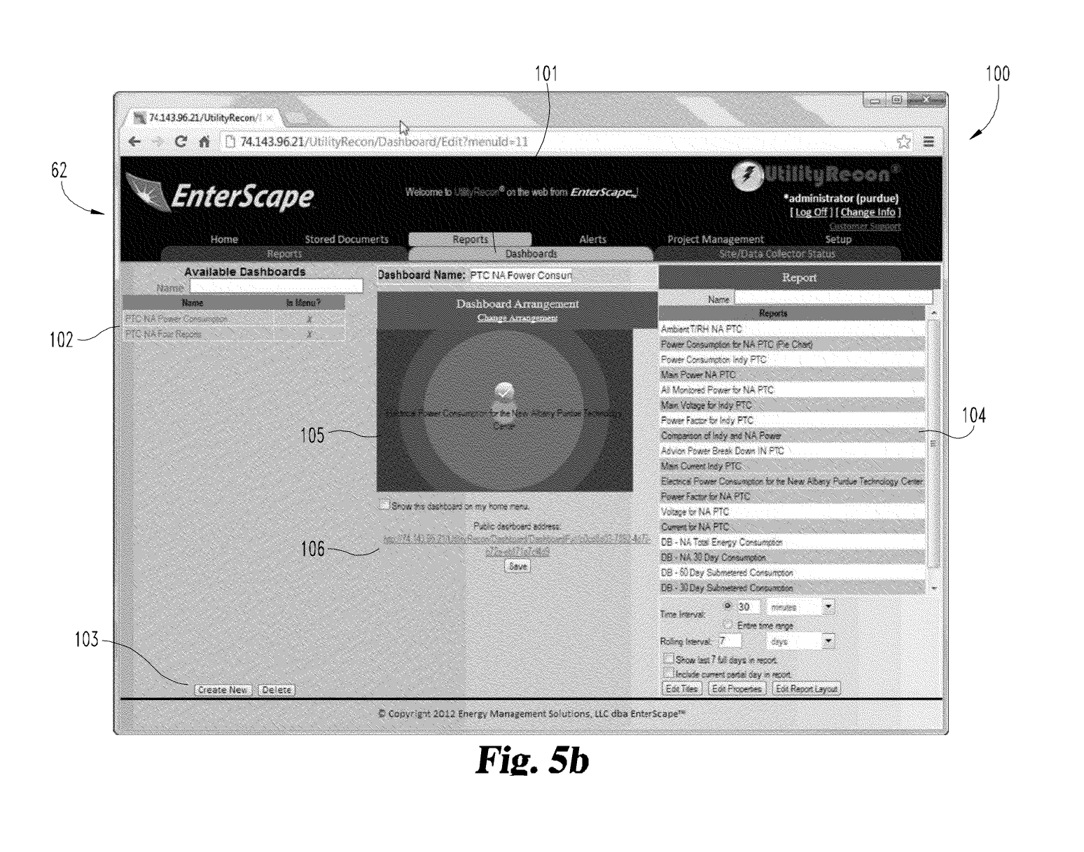

Turning to FIG. 5A, with continued reference to FIG. 1, an screen shot 90 showing an illustrative page and the “Generate Reports” functionality is provided. Screen shot 90 illustrates the screen displayed upon the user's selection of the “Reports” tab 91 on the navigation bar 62 located at the top portion of screen 90 (or on another screen). In the illustrated embodiment, page 90 is served by report engine 36, which is running on a server 30 along with a data repository 34 for data transfer and user authorization purposes. In this form, the user interface utilizes a series of pages, such as page 90, in order to collect a variety of information, such as the entity/facility of interest, the devices of interest, a specified date range, and the like. Upon completing the requested information, the report engine 36 generates the desired report, and may display a portion of it on screen 90. By way of example, one report type may include a chart showing the determined energy usage (in kWh) over the specified date range. In one form, the reports generated by a server 30 and subsequently transmitted to the remote user are in the form of Microsoft Excel Spreadsheets, which may be viewed by the user or saved for subsequent viewing, modification, and/or subsequent distribution to others. Furthermore, in a preferred form, when the reports are generated in the form of a spreadsheet, the spreadsheet includes at least one cell having a formula which determines the value of that cell. For example, in the event of a calculated channel, the underlying channel data is included such that the value of the cell is actually a calculated value rather than a simple number. For example, in the event of a calculated channel which is “30×# of pulses” the cell in the spreadsheet would be “=30×5” rather than the simple integer 150. In a further form, the data for the channels used by an included calculated channel may be included as well, such as in another tab, and may be referenced accordingly in the value of the each cell for a calculated channel, such that its value depends on the value of another cell.

Turning to FIG. 5B, a screen shot 100 showing the “Dashboards” functionality is shown. Screen shot 100 illustrates the screen displayed upon the user's selection of the “Dashboards” tab 101 on the navigation bar 62 located at the top portion of screen 100 (or on another screen). From this screen 100, the user may utilize the provided interface, which is connected to a server 30, to generate one or more dashboard views based upon the data stored in the server's data repository 34. A list box 102 includes the existing dashboard views which may be selected for editing. Additionally, a new dashboard view may be created by selecting the “Create New” button 103 and giving it a name. From there, the new dashboard may be populated with one or more report 104, a layout of those reports as provided within window 105, and a user specified time interval which defines the range over which data will be used in generating the dashboard.

Once the dashboard is established, server 30 may be programmed so as to periodically automatically update the dashboard view. Furthermore, server 30 may publish the dashboard view at a static web-page address, which is defined by static web address 106 of screen 100. This static web-page address may be accessible outside of the security traditional user access restrictions of system 10. This allows for dashboard views to be e-mailed to third-parties, accessed by users without logging into the web based application, and/or to be displayed automatically on a monitor or the like, such as within the actual monitored facility.

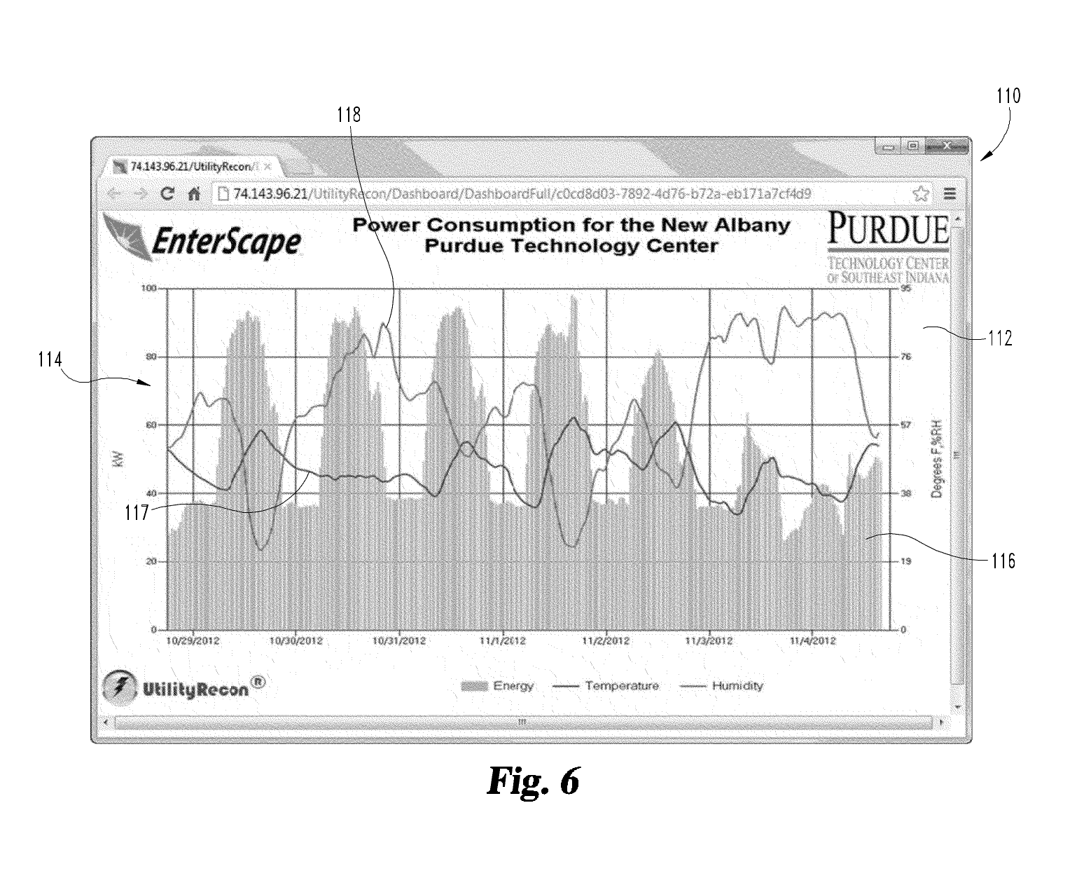

FIG. 6 is a screen shot 110 showing an example dashboard view 112, which includes a graph 114 of the energy used over time 116 as well as the corresponding temperature 117 and relative humidity 118. The example dashboard view 112 may be customized by a remote user to include any of the data collected by, stored by, or readily available to (e.g., via a public source on the Internet) server 30. Furthermore, the update frequency and date/time span of the dashboard may be customized to meet user requirements and desires. These customizations may be made interactively or via iterative refinement of generated reports, depending on the specific implementation used.

As described above, in one form the dashboard view 112 of illustrative page 110 is posted to a web-page located at a static web address by servers 30. The static web address is them made available to the user for subsequent distribution, such as by e-mail or the like to other users. Furthermore, the static web address operates outside of the user access restrictions implemented by the web-based application. Accordingly, the dashboard view 112 may be shared quickly and easily with other within an organization, such as by e-mail or the like, whether they are authorized users or not. Additionally, smart displays may be configured to display a certain dashboard view 112, report, or combination of the above on a smart monitor, television or the like. In a further form, the monitor may cycle through one or more of the above mentioned displays by visiting a series of pre-programmed static web addresses.

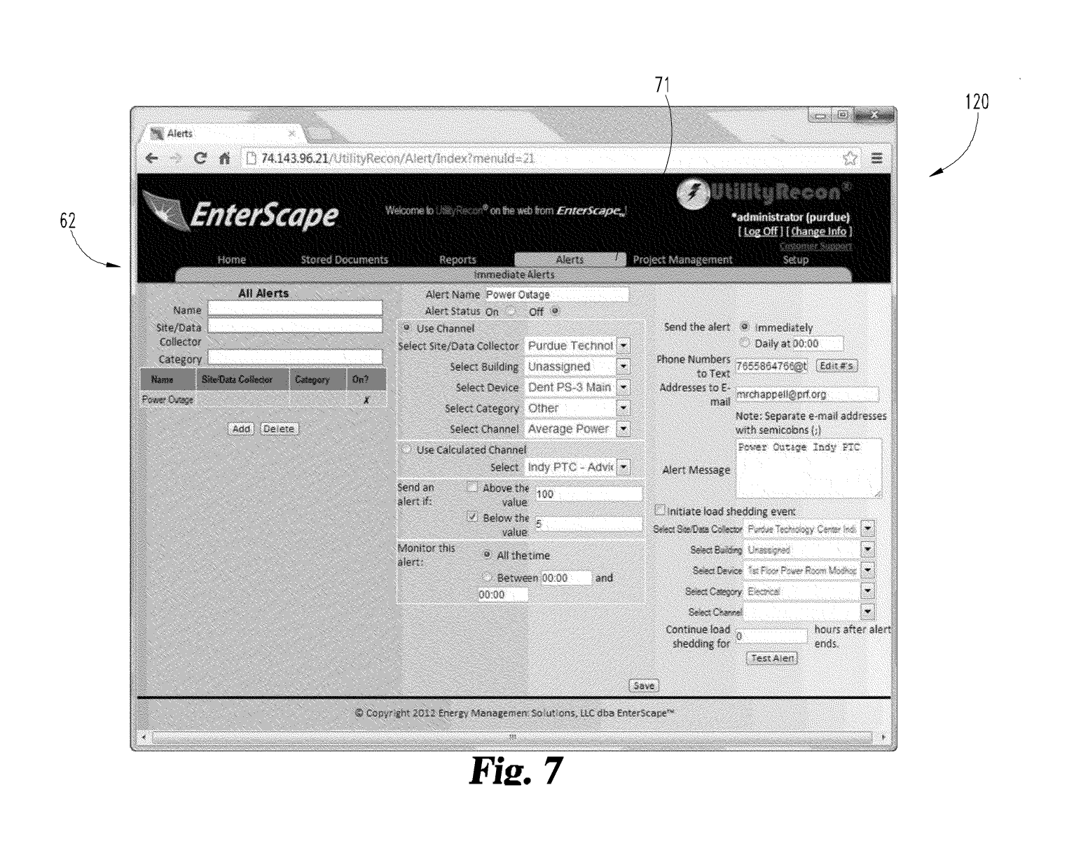

FIG. 7 illustrates a representative screen shot of another screen 120 displayed by the web-based application hosted by server 30. Screen shot 120 illustrates the screen displayed upon the user's selection of the “Immediate Alerts” tab 71 on the navigation bar 62 located at the top portion of screen 120 (or on another screen). The user interface may provide a page, such as illustrative page 120, which allows a user to configure alerts, for delivery via e-mail, text message, or phone call, for events of interest, such as the detection of an anomalous energy usage state in light of the current circumstances. Anomalous events may include: (1) an emergency exception, such as a reading outside of a specified range, which warrants an immediate notification; (2) a daily exception, which is triggered by less urgent events such as a reading outside of a narrower range; (3) a modeled performance alert, which is triggered when a device, such as an air conditioning unit, is behaving outside set parameters established by a calculated model of that circuit's normal performance under the currently known environmental conditions, such as temperature, humidity, etc.; (4) an averaged performance alert, which is triggered when a device, such as an piece of heavy machinery, is behaving outside an average window of peer devices; and (5) a load shedding alert which triggers a signal to 3^{rd} party controllers.

In a further form, the server 30 performs analysis on the collected data stored in the data repository 34 by constructing mathematical computer models (e.g., using techniques of operations research). For instance, the server may calculate the total energy cost for an entity over a specific period of time based on forecast conditions or the expected performance of a device based on specified conditions, such as weather conditions. This information enables a system owner to easily determine the cost of conducting certain necessary activities at a specific time versus another time, or the cost of one system as opposed to another. Additionally, these calculations enable the triggering of modeled performance alerts, as described above.

In still another form, the server 30 may enable a remote user to define tenants or other divisions for sub-metering purposes. In doing so, the total set of various monitoring systems 10 associated with the entity are able to be assigned to distinct subsets which represent the desired tenants or sub-parts. Once defined, all of the functionality described about, including reporting and notifications, may be customized and executed on these subsets. Additionally, multiple-tenant reports and functions can be executed, simply by selecting the desired tenants.

In an additional form, the server 30 may provide access to collected data 21 or processed data 31 for use as input to one or more ERP (Enterprise Resource Planning) systems 58. Due to the large variety of ERP systems in the market and the need to customize each one to a specific business, the interface with ERP systems is necessarily flexible. In one of the simplest manifestations, CSV (comma separated values) files with pre-defined content can be output to a pre-defined location (e.g., a file server on the Internet) by a server 30 for later consumption by an ERP system 58. Another simple implementation would be to allow on-demand queries by an ERP system 58 directly to a data repository 34 on a server 30.

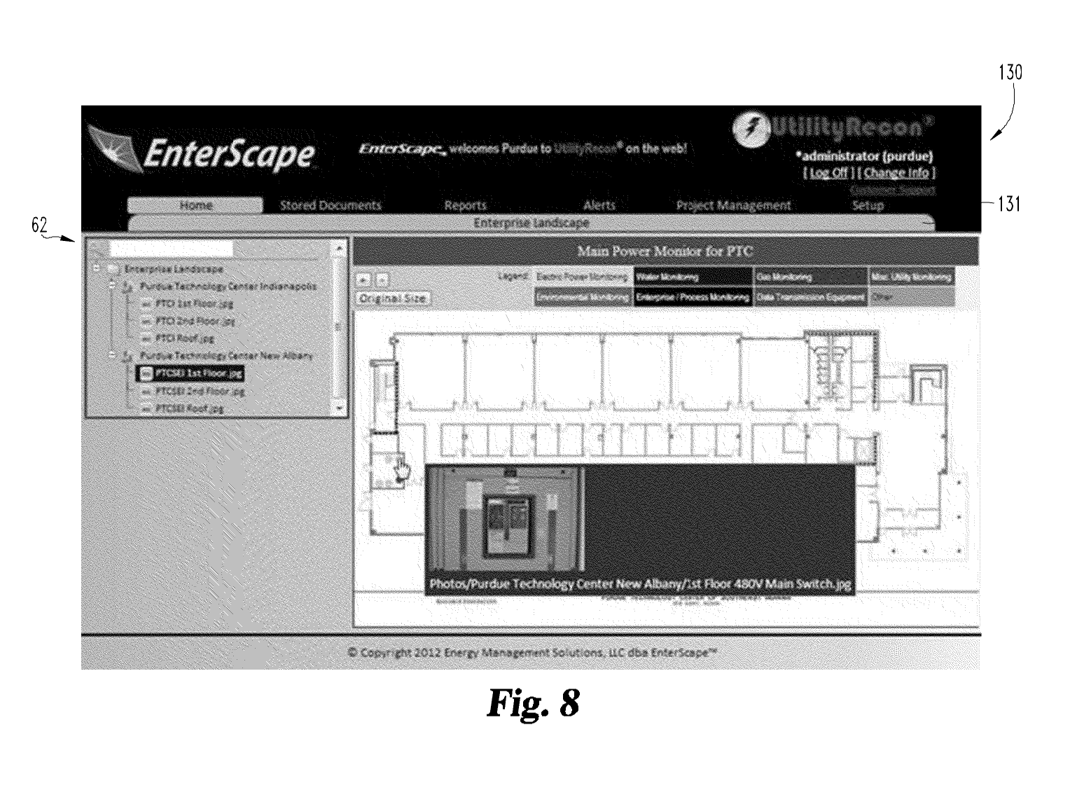

FIG. 8 illustrates a representative screen shot of another screen 130 displayed by the web-based application hosted by server 30. Screen shot 130 illustrates the screen displayed upon the user's selection of the “Landscape” tab 131 on the navigation bar 62 located at the top portion of screen 130 (or on another screen). The user interface may provide a page, such as illustrative page 130, to allow for a user providing static data to upload a map type photo or the like displaying the geospatial arrangement of a monitored facility an its corresponding monitoring systems 18. The photo may be an actual image, blueprint type drawing, map, overhead photo or data sufficient to general an image or comparable display. Furthermore, defined within the photo are geospatial positions which are associated with one or more monitoring systems 18, and perhaps more specifically one or more utility meters 12, environmental meters 14, or other meters 16. Each position is indicated by a user selectable icon, such as a color coded button, or the like, which may indicates the underlying sensor's type (i.e. utility, environmental, etc.). Upon the user's selection of the icon, the most recent data provided by that sensor may be displayed, or, in a further form, a second level map or layout may be displayed showing the location more specifically. In an alternate form, a series of one or more nested levels may be accessible from the icon which includes an actual photograph of the sensor and its position. This enables a user seeking to locate a specific sensor to make easily access the data from a selected sensor and understand its location, such as in the event of a malfunction or the like.

The collection of the data described above would normally be a time-consuming process, the automated natured of it reduces labor costs associated with operating, evaluating, and maintain such a system. Furthermore, the data collected is much more accurate, granular, and up to date as the system does not rely upon utility bills or other comparable reports which are often generated weeks after the time when the data are generated.

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the inventions as described herein and/or by the following claims are desired to be protected.

What is claimed is:

1. A method for managing utility data from multiple remote locations, comprising the steps of:
receiving a first set of utility data collected by a first plurality of sensors located at a first site using one or more central servers, wherein said first site is located at a separate geographic location from said one or more central servers and said one or more central servers and said first plurality of sensors are connected by a digital network;
storing said first set of utility data in a data store connected to said one or more central servers;
providing a web-based application which enables an authorized user to access said first set of utility data using said one or more central servers;
receiving via said web-based application configuration data in association with the portion of said first set of utility data which was collected by a first sensor within said plurality of sensors, wherein said configuration data specifies a unit type and a formula including at least one mathematical operator to be applied to said portion of said first utility data;
applying said formula to each data point within said portion of said first set of utility data to generate a first formatted set of utility data using said one or more central servers; and
displaying a report generated based upon at least said first formatted set of utility data to a remote user via said web-based application.

2. The method of claim 1, wherein said configuration data also includes an indicator of whether or not prior data received from said first sensor is cumulative of subsequent data received from said first sensor.

3. The method of claim 1, further comprising the steps of:
receiving a second set of utility data collected by a second plurality of sensors located at a second site using said one or more central servers, wherein said second site is located at a separate geographic location from said central server and said first site and said central server and said second plurality of sensors are connected via said digital network; and
storing said second set of utility data in said data store.

4. The method of claim 3, further comprising the steps of:
receiving via said web-based application second configuration data in association with the portion of said second set of utility data which was collected by a second sensor within said second plurality of sensors, wherein said second configuration data specifies a second unit type and a second formula including at least one second mathematical operator to be applied to said portion of said second utility data;
applying said second formula to each data point within said portion of said second set of utility data to generate a second formatted set of utility data using said one or more central servers; and
displaying a second report generated based upon at least said second formatted set of utility data to a second remote user via said web-based application.

5. The method of claim 4, wherein said first remote user and said second remote user are the same.

6. The method of claim 1, wherein said report is a table.

7. The method of claim 1, wherein said report is a graph.

8. The method of claim 1, wherein said report is a spreadsheet.

9. The method of claim 9, wherein said report includes at least one cell having a formula which determines the value of that cell.

10. The method of claim 9, wherein said formula is based upon the values of other cells within the spreadsheet.

11. A method for triggering alerts based upon utility data received from multiple remote locations, comprising the steps of:
receiving a first set of utility data collected by a first plurality of sensors located at a first site using one or more central servers, wherein said first site is located at a separate geographic location from said one or more central servers and said one or more central servers and said first plurality of sensors are connected by a digital network;
storing said first set of utility data in a data store connected to said one or more central servers;
providing a web-based application which enables an authorized user to access said first set of utility data using said one or more central servers;
receiving via said web-based application configuration data and alarm conditions in association with the portion of said first set of utility data which was collected by a first sensor within said plurality of sensors, wherein said configuration data specifies a unit type and a formula including at least one mathematical operator to be applied to said portion of said first utility data and said alarm conditions specify at least one threshold and a device to be alerted;
applying said formula to each data point within said portion of said first set of utility data to generate a first formatted set of utility data using said one or more central servers;
monitoring said first formatted set of utility data using sad one or more central servers to determine whether said at least one threshold is exceeded or deceeded; and
in the event said at least one threshold is exceed or deceeded, transmitting an electronic alert to said device to be alerted.

12. The method of claim 11, wherein said electronic alert is a text message or an e-mail.

13. The method of claim 11, wherein said transmitting an electronic alert is delayed until a defined time window.

14. The method of claim 11, wherein the device to be alerted is said first sensor and said electronic alert triggers a load shedding event in a device connected to and being monitored by said first sensor.

15. A system for distributing utility usage reports based upon utility data received from multiple remote locations, comprising:
at least one central server for acquiring energy usage data from a plurality of energy usage meters, wherein said at least one central server is located at a central location remote from the energy usage meters;
a data store connected to said at least one central server for storing the acquired energy usage data;
a report generator connected to said data store for generating and periodically updating reports representative of the energy usage data associated with one or more combinations of the energy usage meters; and
a web server for publically hosting the reports generated by said report generator, wherein each report generated by said report generator is hosted at a unique static web address which is accessible absent any user authorization requirements which may be required by said electronic communication subsystem.

16. A system for geospatially displaying utility usage data, comprising:
at least one central server for receiving floor plan data indicative of the arrangement of a set of energy usage meters at a facility and acquiring energy usage data from said plurality of energy usage meters, wherein said at least one central server is located at a central location remote from said facility;
a data store connected to said at least one central server for storing the floor plan data and the acquired energy usage data;
a display generator connected to said data store for generating a geospatial map of said facility including a user selectable representation of the location of each of said energy usage meters; and
a web server for displaying the geospatial map of said facility to a remote user and, upon user selection of an energy usage meter on said geospatial map, displaying at least a portion of the energy usage data acquired from said selected energy usage meter.
